(19) United States
(12) Patent Application Publication
(10) Pub. No.: US 2009/0132938 A1
(43) Pub. Date: May 21, 2009

(54) SKINNING SUPPORT FOR PARTNER CONTENT

(75) Inventors: David Gardner, Covington, WA (US); Erin Honeycutt, Redmond, WA (US); Veronica Law, Seattle, WA (US); Jeffrey Margolis, Seattle, WA (US); Peter Rosser, Renton, WA (US); Christen Coomer, Seattle, WA (US)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 11/941,648

(22) Filed: Nov. 16, 2007

(51) Int. Cl. G06F 3/00

(52) U.S. Cl. 715/762

(57) ABSTRACT

The technology described herein is a system and methods for generating a branded background for user interfaces. In one embodiment, the background is generated based on a background template. A content partner may customize the background by providing a hue value, artwork and a logo. The background of the user interface is tinted a color associated with the hue value. The artwork and logo is placed in the background, and in one embodiment, the artwork comprises a watermark version of the artwork. Gallery content may also be layered over the background to create a UI having a theme.

### BACKGROUND

Many software applications provide a user with the ability to interact with the application in some manner. The mechanism by which a user is permitted to interact with a software application is referred to as a user interface (“UI”). User interfaces typically provide controls that can be engaged by a user to cause a predetermined result. For example, in Windows XP, Media Center edition (MCE), the “my music” gallery page allows a user to sort the music by artist, album, playlist or genre. A user might use their mouse to click on the “album” toolbar so that all albums stored in MCE are displayed by album cover. The background for the “my album” gallery page and the gallery page displaying the album covers has the same color (Windows blue).

UIs have, in the past, been generally fixed insofar as their layout, functionality and appearance is concerned. One primary reason for this stems from the desire to impart standardization to various UIs. Yet, against the backdrop of standardized UIs, interest has begun to surface with providing the ability to impart a different look to various UIs. For example, the background of most gallery pages in MCE (e.g., recorded tv gallery page) is tinted with the Windows blue, regardless of the UI. Increasingly, content partners who are providing the content for the UIs want the capability of “branding” their product. A content partner is any party that creates or distributes content. By way of example only, a content partner may be a television network (e.g., ABC), a movie studio (e.g., Paramount Studios) or a content aggregator (e.g., Netflix).

In computing, skins may be associated with themes such as custom graphical appearances that can be applied to certain software in order to suit the different tastes of different users. The process of writing or applying such a skin is known as “skinning.” Applying a skin changes the look and feel of a piece of software.

### SUMMARY

The technology described herein comprises a system and methods for generating a branded background for a UI. One example of a UI having a branded background is an “arrested development” television gallery page in MCE. The background of the “arrested development” gallery page may have a “theme” associated with the television show. For example, the background and various gallery content may be tinted orange (the color associated with “arrested development”), and include an image of one of the “arrested development” characters and the msn logo.

One aspect of the technology described herein is to brand a user interface associated with the content displayed in the UI. In one embodiment, a content partner chooses the layout of a user interface template. The UI template contains predetermined locations for displaying the content and designates a background for the UI. In one embodiment, each UI template preferably contains a predetermined location for displaying a logo, an image and various other content. In another embodiment, each UI template contains a specific background that can be tinted a color. In one embodiment, the content partner provides the logo, an image and a hue value, all associated with the content to be displayed in the UI.

Another aspect of the technology described herein is to generate a branded user interface. In one embodiment, the content partner provides a hue value associated with a particular color. The background of the user interface template is then tinted the specified color. If the content partner provides an image, the image is then placed the UI template's image location. If the content partner provides a logo, the logo is placed in the UI template's logo location. Once the UI template is generated, content is then layered over the branded UI template.

Yet another aspect of the technology described herein is to efficiently generate the branded user interface. In one embodiment, the log and image provided by the content partner are stored remotely. Tinting the background of the UI template, and importing image files from a remote location allows the system to pre-download the images while the branded user interface is being tinted. By only storing a locator to the images locally, the amount of storage space required by the system is reduced. In another embodiment, the size of the image files provided by the content partner is limited, allowing the system to quickly download and layer the images over the background.

Another aspect of the technology described herein is to provide a system that generates the branded user interface. In one embodiment, the system includes a memory and a processor. The memory is configured to store a background template, a hue value provided by the content partner, a logo provided by the content provider, and a locator associated with an image provided by the content provider. The processor is configured to retrieve the image provided by the content provider, place a watermarked version of the image in the background template, place the logo in the background template, and tint the background template with a color associated with the hue value. In another embodiment, the memory stores a locator associated with the logo and the processor is configured to retrieve the logo.

### BRIEF DESCRIPTION OF THE DRAWINGS

FIG. 1 depicts a flow diagram displaying exemplary steps for generating a branded background;

FIG. 2 depicts a flow diagram displaying exemplary steps for placing a watermarked version of an image in the background;

FIG. 3 depicts a flow diagram displaying exemplary steps for tinting a mask of the background template;

FIG. 4 depicts an embodiment of a user interface template;

FIGS. 5A-5C depict exemplary stages of the branded background and user interface;

FIG. 6 depicts the exemplary user interface shown in FIG. 5C with additional gallery content layered over the background;

FIG. 7 depicts another embodiment of an exemplary user interface having a branded background; and

FIG. 8 depicts a block diagram of an exemplary computer system for performing the methods described herein.

### DETAILED DESCRIPTION

For discussion purposes only, the various aspects of the present technology will be discussed in reference to Windows XP, Media Center edition (“MCE”). The present technology is, of course, not limited to this specific product, and applies to any other user interface that may be skinned.

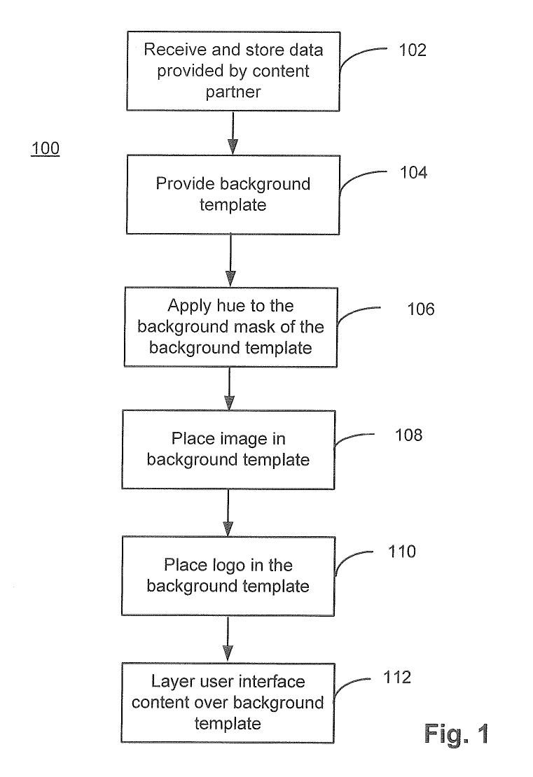

FIG. 1 illustrates a flow diagram 100 displaying exemplary steps for skinning a user interface. Content partners interested in skinning a UI within MCE may provide several pieces of data to customize the UI. As will be discussed in more detail later, the data provided by the content partner will be incorporated into the UI.

In step 102, the data supplied by the content partner is received and stored by the system. In one embodiment, the content partner provides a logo, a hue value and artwork. The artwork may also be referred to as an “image” or “piece of art.” In one embodiment, the data provided by the content partner will be stored locally. In another embodiment, some of the data may be stored remotely. For example, the artwork may be stored on a remote server, and is available through URL redirects.

In step 104, the method 100 provides the background template. The background template provides the background for the UI. In one embodiment, the background template is stored locally. Having a local background template allows for an efficient rendering of the branded UI. As will be discussed in more detail later, in one embodiment, the background template includes a mask and a predefined location for inserting the logo and artwork provided by the content partner.

In step 106, the mask of the background is tinted. The content partner may choose what color the mask will be tinted. The color the mask is tinted is based on the hue value received from the content partner in step 102. Suppose Microsoft Network (“msn”) has television gallery pages displayed in MCE for its popular television show “arrested development.” Msn may customize the “arrested development” gallery pages by providing a hue value specifying what color the mask should be tinted. The television show “arrested development” is often associated with a particular shade of orange. Thus, msn may provide a hue value that is associated with the particular shade of orange. When the branded background of the UI is being rendered, the mask will be tinted with the color associated with the hue value provided by msn. Additional details of the tinting process are provided hereinafter.

Msn may also want to further strengthen the theme or branding of the “arrested development” gallery pages. To do so, msn may provide artwork that will be displayed in the background. If the content partner provides artwork, in step 108, the method 100 places or inserts the artwork in the background template. The artwork is placed in the background in a predetermined image location set by the background template. In one embodiment, the content partner may not modify the image location in the background template. In an alternative embodiment, the content partner may modify or choose the image location within the background template.

For example, msn may want the background of the “arrested development” gallery page to display an image of one of the “arrested development” characters. In one embodiment of method 100, msn provides a full-color image of the character and the full-color image is stored in step 102. In an alternative embodiment, msn provides a black and white version of the image and the black and white version of the image is stored in step 102. In another embodiment, the size of image file provided by the content partner is restricted. Restricting the artwork file size allows for faster downloading of the image from the remote storage location.

Msn may also want to increase the branding of the “arrested development” gallery page by adding a logo in the background. If msn provides a logo file, in step 110, the logo is inserted into the background. As will be discussed in more detail later, the background template contains a predefined logo location. In one embodiment, the logo provided by the content partner is not altered in the background template.

Steps 102-110 illustrate exemplary steps for generating the background of the UI. The background generated based on the logo, hue value and artwork provided by msn, in one embodiment, will comprise the background for all “arrested development” gallery pages. In other words, as the user moves between “arrested development” gallery pages, the background remains uniform. For example, the msn logo and artwork is displayed in the background and the background is tinted the same shade of orange for every “arrested development” gallery page. In an alternative embodiment, the background may change depending on the gallery page selected by the user.

In step 112, the gallery content is layered over the background. For example, in the “arrested development” gallery page, the gallery content layered over the background may include scenes from various “arrested development” episodes, static or dynamic text, the title of the television show, and so on. In one embodiment, the gallery content is layered over the background in predetermined locations. This way, the gallery pages displayed in MCE present a similar look and feel to the user regardless of the branding.

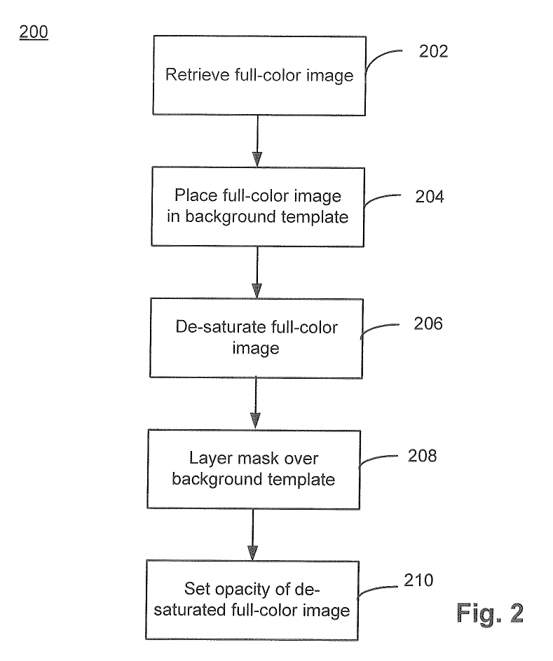

FIG. 2 illustrates a flow diagram providing exemplary steps for rendering the image or artwork in the background (step 108 in FIG. 1). In one embodiment, the method 200 renders a watermarked version of the artwork in the background template. In another embodiment, the method 200 simply inserts the artwork provided by the content provider into the background template.

In one embodiment, the content partner provides a full-color image. In another embodiment, the content partner provides a grey-scale image. In yet another embodiment, the content partner provides a black and white image. For purposes of describing method 200, suppose the content provider provided a full-color image. The full-color image may be stored locally or remotely. For example, the full-color image may be hosted or stored on the content partner's server (or any other storage device) with, for example, a corresponding URL stored in the local memory. Maintaining the image on the content partner's server reduces the amount of local memory required by the system. In step 202, the method 200 retrieves the artwork provided by the content partner.

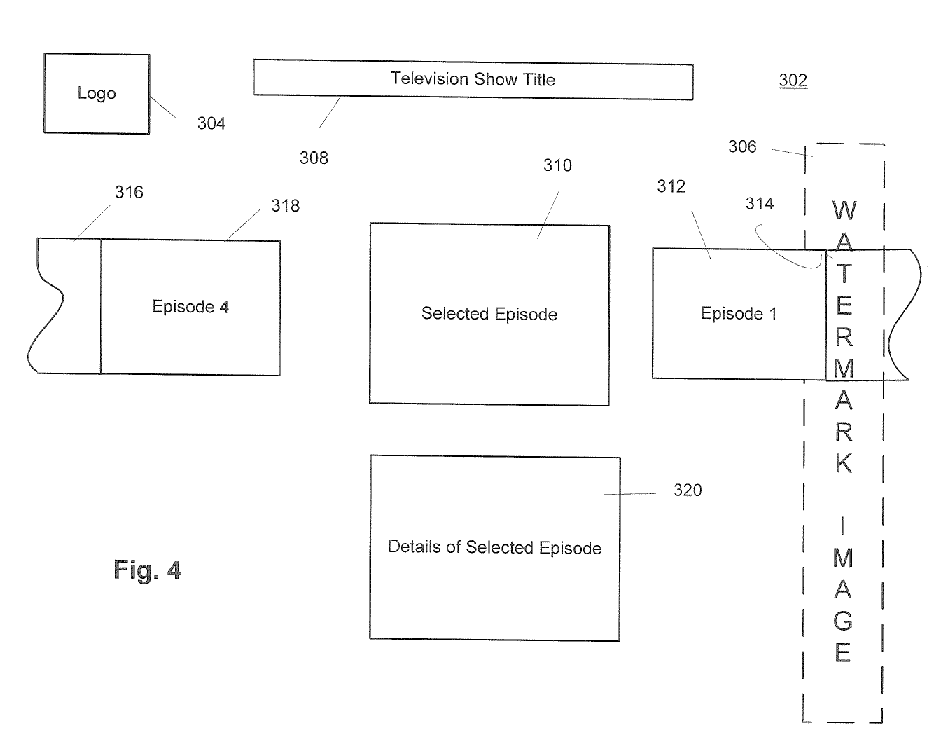

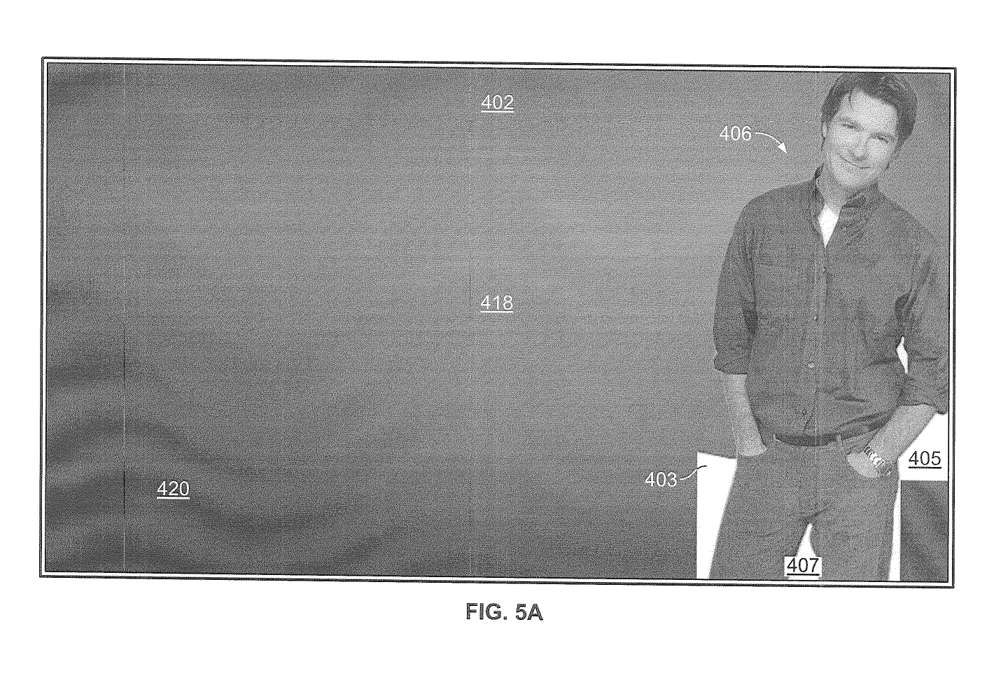

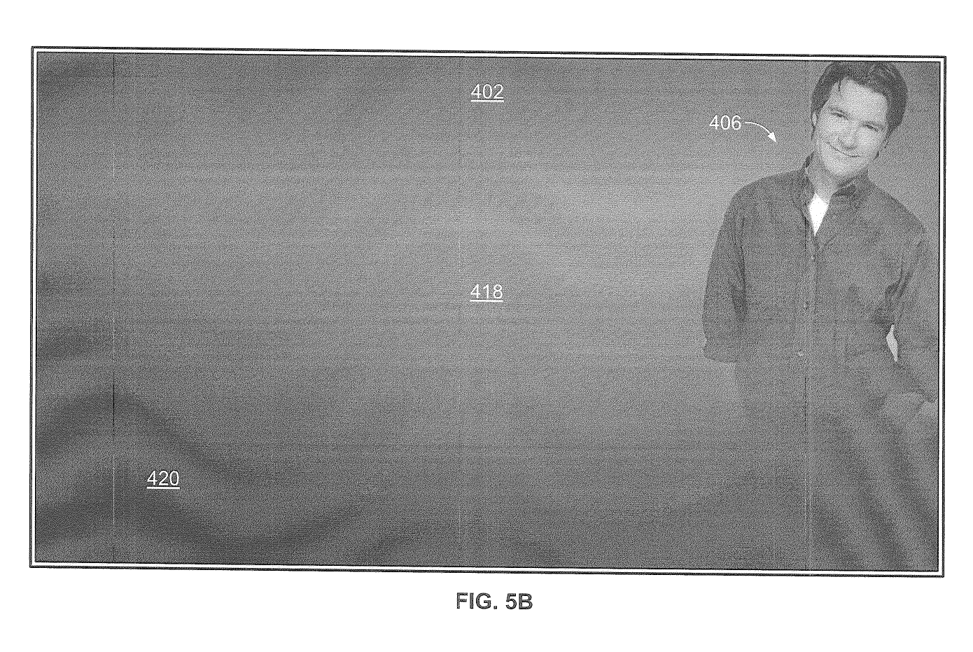

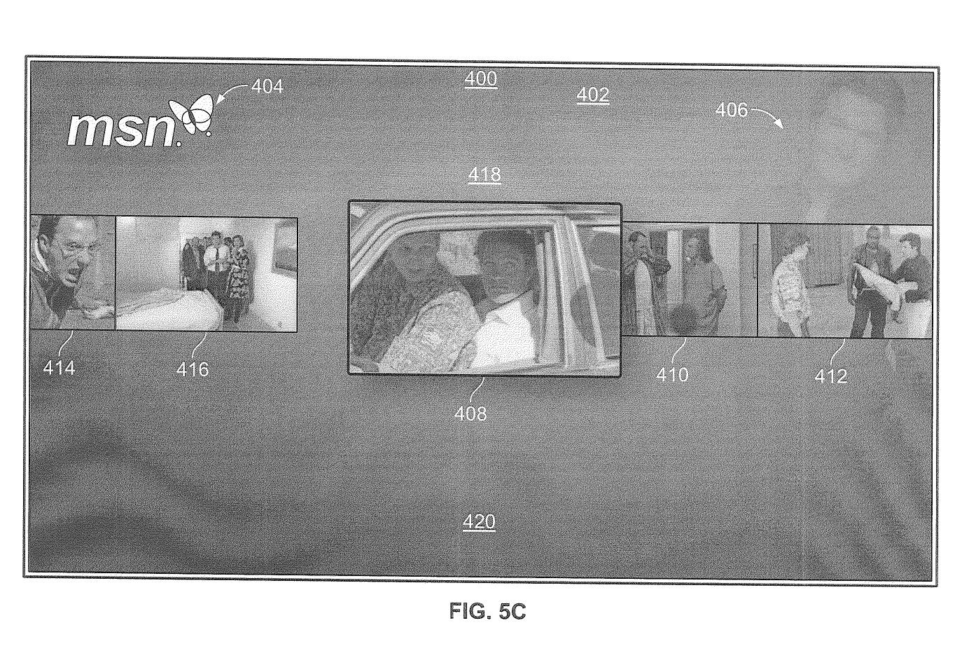

In step 204, the full-color image provided by the content partner is placed or inserted in the background template. The image location in the background template is predetermined. FIG. 4 illustrates an exemplary background template having a predetermined image location 306. FIG. 5A illustrates that, in one embodiment, the artwork is not fully integrated into the background when initially placed into the background template (more details later).

In step 206, the full-color image is de-saturated to remove the color from the image. De-saturating an image is known within the art and therefore, additional description is not required. In one embodiment, the full-color image is fully de-saturated. In another embodiment, the full-color image is partially de-saturated. In yet another embodiment, the full-color image is not desaturated at all. If the full-color image is not desaturated at all, step 206 would not be performed.

In step 208, the tinted mask is layered over the background template to blend the de-saturated image (if the image is de-saturated) into the background. In step 106, the mask in the background template was tinted. As shown in FIG. 5A, inserting the image into the background template may affect the pattern in the mask. Layering the tinted mask over the background template, after the image is placed in the template, covers any graphic irregularities that resulted from inserting the image into the background template (See FIG. 5B). In one embodiment, the de-saturation process in step 206 is performed before the tinted mask is layered over the template in step 208. In another embodiment, the tinted mask is layered over the template in step 208 before the image is desaturated in step 206. In another embodiment, steps 206 and 208 are performed concurrently.

In step 210, the opacity of the image is set in step 210. Setting the opacity gives the desaturated image a watermarked effect. For discussion purposes only, 100% opacity refers to artwork or an image that has near-infinite opacity and 0% opacity refers to an image or artwork that has near-zero opacity. In one embodiment, the opacity of the desaturated image is predefined by the background template. For example, the opacity of the desaturated image may be set to 20% opacity. The opacity of the image may be set to any suitable level regardless of whether the image is desaturated or not.

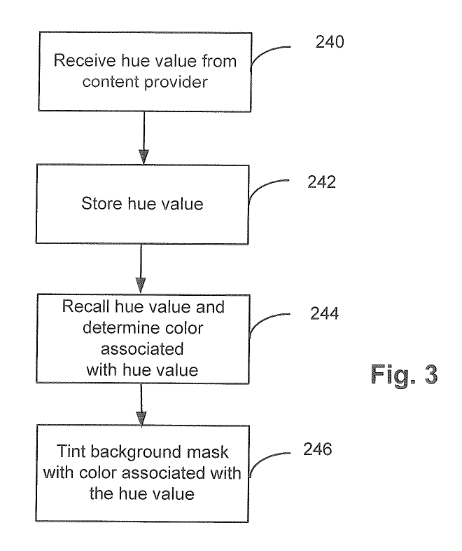

FIG. 3 illustrates a flow diagram 230 providing exemplary steps for tinting the mask of the background template (step 106 in FIG. 1). In one embodiment, the mask is tinted based on a color associated with an HSV (Hue-Saturation-Value) model. The HSV model is also commonly referred to as the HSB (Hue-Saturation-Brightness) model. As will be discussed in more detail later, some of the gallery content may also be tinted. In an HSV model, the hue values typically range between 0-360. Each hue value in the HSV model corresponds to a single color. For example, a hue value of zero is associated with the color red, a hue value of forty-five is associated with a shade of orange and a hue value of fifty-five is associated with a shade of yellow. In another embodiment, the mask is tinted based on an RGB (Red-Green-Blue) color model.

As discussed above, the content partner may provide a hue value to specify what color the mask will be tinted. In one embodiment, the hue value provided by the content partner is stored in local memory. In step 240, the hue value is retrieved from the local memory. In step 242, the method 230 determines the color associated with the hue value. The HSV model is commonly used in computer graphics applications. In various application contexts, a user must choose a color to be applied to a particular graphical element (e.g., each pixel of the mask). When used in this way, the HSV color wheel is often used. In it, the hue is represented by a circular region. A separate triangular region may be used to represent saturation and value. In this way, a color can be chosen by first picking the hue from the circular region, then selecting the desired saturation and value from the triangular region. In one embodiment, the saturation and value of each pixel in the mask is preset. Thus, by providing the hue, content partner provides the color the mask will be tinted.

Once the color associated with the hue is determined, the method 230 tints the mask with the color, in step 244. For example, if the mask contains a gradient pattern, step 244 tints each pixel in the pattern. In one embodiment, the hue provided by the content partner also provides the color for tinting the gallery content (e.g., text, program title, etc.). Tinting the mask as well as the gallery content strengthens the branding or theme for the entire UI.

FIG. 4 illustrates one embodiment of a UI template. In general, a UI template comprises a graphical display that contains devices, or content, that enables a user to perform interactive tasks. To perform these tasks, the user of the UI does not have to create a script or type commands at a command line. Often, the user does not have to know the details of the task at hand. In the MCE embodiment, the UI template 302 shown in FIG. 4 provides a “master” layout for the “arrested development” gallery page.

The UI template 302 is an exemplary template for a television gallery page in MCE. The template 302 displays episodes of a television show by season. The template 302 includes a logo location 304, an image location 306, a show title location 308, a selected episode display location 310, other episode locations 312-318 and a summary location 320. Each of these locations is predefined in the template 302. In this embodiment, the logo location 304 and the image location 306 are elements or components of the background template. The other components of the UI template 302—the show title location 308, the selected episode display location 310, other episode locations 312-318 and the episode summary location 320—are referred to as “gallery content.” Similar to the logo location 304 and the image location 306, the location of the gallery content is predetermined in the UI template 302. In one embodiment, the content partner may choose the UI template. In another embodiment, the UI template is determined by the type of UI that will be displayed. For example, in MCE, the UI template may be the only layout choice for all television gallery pages.

In the UI template 302, the title of the television show is displayed in location 308. A selected episode 310 from a particular season is displayed in the center of the UI. The selected episode 310 is also the largest episode display. Additional episodes from the same season are displayed in locations 312-318. A summary of the selected episode is displayed in location 320 below the selected episode 310. As discussed above, the background components include the logo, the artwork and the mask. The logo 304 is displayed in the upper left-hand corner of the UI. The image 306 is displayed along the right side of the UI, and extends vertically across the UI substantially from the top to the bottom of the UI.

The episode displayed in the location 310, the additional episode displayed in locations 312-318, the title displayed in location 308 and the summary displayed in location 320 are provided by the content partner. The gallery content displayed in each of these locations will change depending on the user's actions. For example, suppose a user clicks on the episode displayed in locations 312. The mouse click triggers the execution of a callback that moves the episode the user clicked from the location 312 to the location 310. In addition, a summary of the episode the user clicked on is now displayed in location 320. This kind of programming is often referred to as event-driven programming. The event in the example is a mouse click. In event-driven programming, callback execution is asynchronous, controlled by events external to the software. Other methods for creating a UI are within the scope of the technology described herein.

FIGS. 5A-5C illustrate exemplary stages of the UI as it is generating according to the method 100. In particular, FIGS. 5A-5C illustrate various stages of an “arrested development” gallery page. In FIG. 5A, the mask (shown as background 402) includes a gradient pattern. In this embodiment, the background 402 has a lighter central portion 418 transitioning to a darker portion 420. At this stage of generating the background 402, the mask has already been tinted according to the hue value provided by the content partner. FIG. 5A further illustrates that the artwork 406 has been inserted into the background template. In this embodiment, inserting the artwork 406 has created irregularities in the background 402 such that the artwork 406 is not blended into the background 402. For example, the background in FIG. 5A has irregularities 403, 405 and 407.

FIG. 5B illustrates the UI 400 after step 208 is completed. In step 208, the tinted mask 402 is layered over the artwork 406. Layering the mask 402 over the artwork 406 covers the irregularities 403, 405 and 407 and blends the artwork 406 into the background 402. Blending the artwork 406 into the background 402 displays the artwork 406 as an image that is integrated into the background 402.

FIG. 5C illustrates the UI 400 after the logo 404 has been inserted into the background 402. As discussed above, in one embodiment, the background 402 remains constant for each “arrested development” gallery page. Thus, regardless of the gallery content displayed in the UI 400, the background 402, the artwork 406 and the logo 404 displayed in the UI 400 remain unchanged. FIG. 5C illustrates the episodes displayed in the UI 400. The episode display locations 408-416 are layered over the background 402.

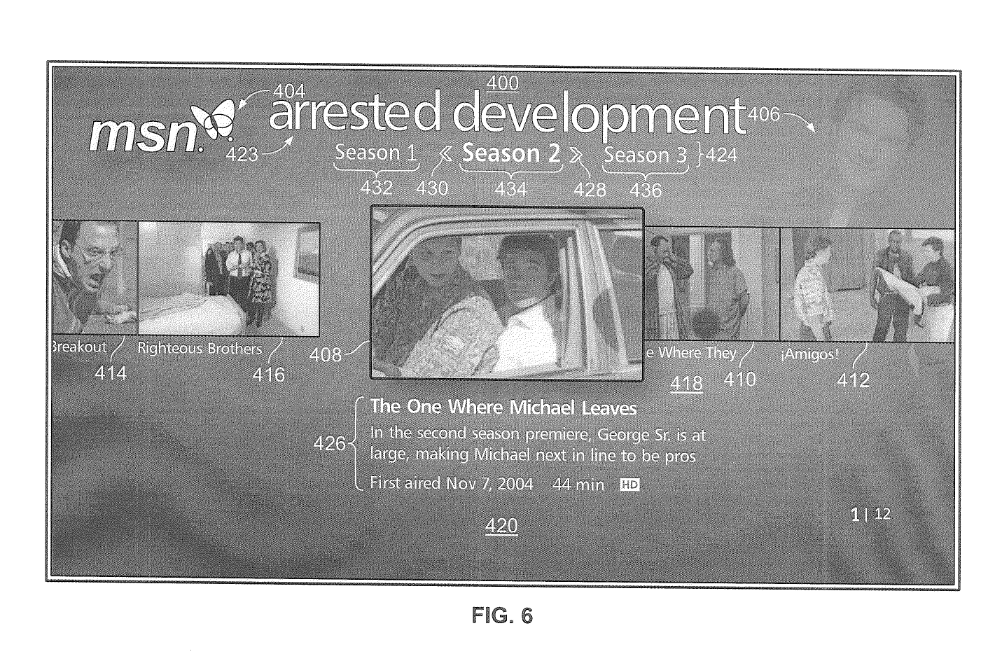

FIG. 6 illustrates an example of an “arrested development” gallery page in MCE, based on the UI template 302 shown in FIG. 4. The show “arrested development” is often associated with the color orange. Thus, the background 402 has been tinted orange based on the hue value provided by msn. The background 402 has a gradient pattern, having a brighter center portion 418 extending to a darker perimeter portion 420. Tinting the background 402 does not modify the gradient pattern provided by the template 302. The selected episode window 408, and the other episode windows 410-416 each display a scene from an episode within the same season (Season 2 as shown in FIG. 6). Each of these windows 408-416 are displayed horizontally across the background 402. The unselected or other episode windows 410-416 may be displayed in any order. The content displayed in each window 408-416 is provided by msn. In one embodiment, each piece of content is downloaded into the UI 400.

The logo window 404 displays the logo provided by msn in the upper left-hand corner of the background 402 (because msn chose template 302). Here, the logo is msn's network logo—a stylize “msn” with a superscript butterfly image. Msn may, of course, provide any logo it chooses. A watermark version of the image provided by msn is displayed in the watermark window 406 (as predetermined by template 302).

The UI 400 in FIG. 6 includes gallery content layered over the background. The gallery content is provided by msn. In this embodiment, the gallery content includes the graphical display of the television show 423, a season selection interface 424, a scene from each episode displayed in the episode windows 408-416, the selected episode summary 426 and a subtitle for each of the unselected episodes. The season selection interface 424 displays three seasons: Season 1 432, Season 2 434 and Season 3 436; and includes a next pivot 428 and a previous pivot 430. The pivots 428 and 430 allow a user to advance to the next season of episodes or return to the previous season of episodes. The background template 302 predefines the appearance of the interface 424. For example, the selected season (Season 2 434) is larger than the prior season (Season 1 432) and the following season (Season 3 436). The background template 302 also presets the opacity of the seasons displayed in the interface 424. For example, the UI 400 displays Season 2 434 at 100% opacity and Season 1 432 and Season 3 436 at 75% opacity. The episode summary 426 is also set to 100% opacity.

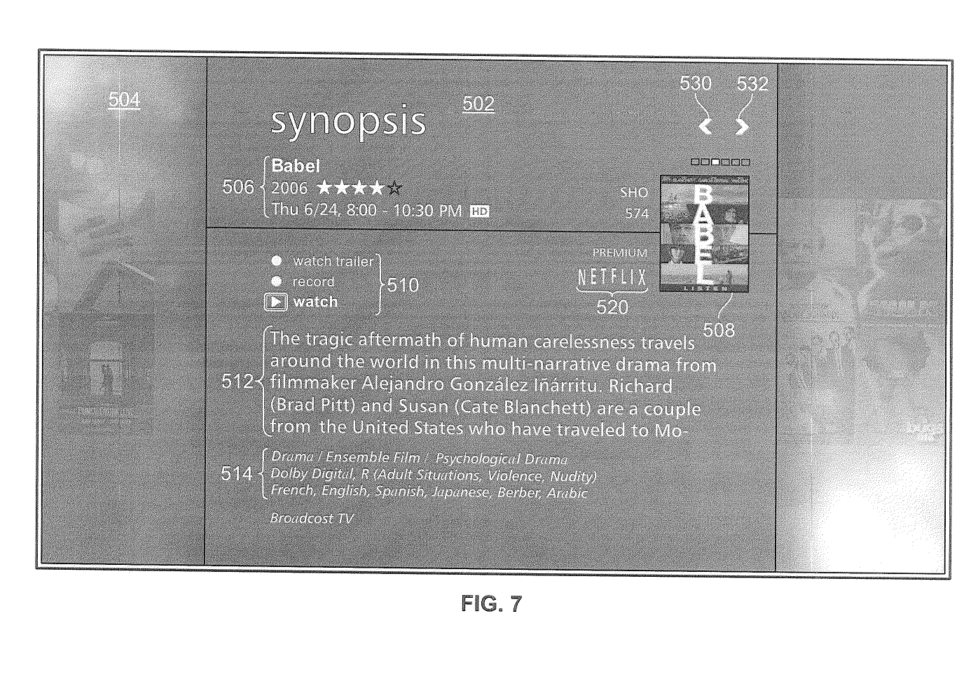

FIG. 7 illustrates one embodiment of a movie details page 500. The UI 500, which is an embodiment of a movie gallery page in MCE, displays details for a movie selection. The user interface 500 is generated from a user interface template similar to the examples provided above for the television gallery page. In this embodiment, the user interface 500 includes a foreground portion 502 and a background portion 504. The foreground portion 502 and the background portion 504 are preferably tinted the same color based on the hue value provided by the content partner. FIG. 7 illustrates a user interface 500 displaying a synopsis for Babel, which is being provided through Netflix®. Netflix marketing and advertising is associated with the color red (e.g., the envelope the DVD is shipped in is red, Netflix's website has a red background, etc.). Thus, Netflix may want the foreground 502 and the background 504 of the UI 500 to be tinted the Netflix shade of red in order to create immediate recognition by a user that the page is sponsored by Netflix.

The foreground 502 and the background 504 may be tinted “Netflix red.” Netflix initially provides a hue value based on the HSV model. Here, the hue value is associated with the shade of red Netflix would like the foreground 502 and the background 504 to be tinted. The particular color associated with the hue value provided by Netflix is identified. In step 244, the foreground 502 and background 504 are tinted with the color. In one embodiment, the foreground and background are tinted similar to tinting the mask described above. In this embodiment of the UI 500, the movie poster 508 and content partner logo 520 are not tinted. The UI template, similar to the UI template for the UI 400, presets the opacity for each piece of content displayed in the UI 500.

The user interface 500 contains various elements in the foreground 502. By way of example only, the foreground 502 contains a summary area 506, a poster area 508, viewing options 510, a movie summary 512, movie details 514 and the content partner logo 520. The summary 506 displays the title of the movie, the year the movie was released, a movie rating and the date/time the movie will be shown. The summary area 506 displays the movie title (“Babel”), the year Babel was released (2006), the movie rating (4 out of 5 stars) and the showing time (Thursday, June 24 at 8 pm). The summary 506 also includes an “HD” symbol indicating that Babel is available in high definition, and the channel to view the movie (Showtime, Ch. 574).

The UI 500 provides several viewing options. The viewing options 510 provided by the template 500 include “watch trailer,” “record” and “watch” movie. Other options may be available (e.g., download movie). A summary 512 of the movie is displayed below the viewing options 510. In this embodiment, the summary 512 provides a brief synopsis of the movie. Movie details 514 are displayed near the bottom of the UI 500, providing, among other things, the movie rating (R), the movie category (drama) and the available languages (French, English, etc.). The template 500 also includes pivots 530 and 532 for previewing the next movie gallery or a prior movie gallery. The template 500 may include other features.

Similar to the UI 400, the locations for the gallery content is predetermined. For example, the location of the summary 506, the movie poster 508, the viewing options 510, the summary 512 and the logo 520 are all predetermined by the UI template. In this embodiment, an image of the actual Babel movie poster is displayed along the right side of the foreground 502. The predefined location for the content partner's logo 520 is adjacent the movie poster 508. The summary 512 is located in the bottom center of the foreground 502 and has the larger text. The content partner can choose a different UI template to display the information in a different manner. Similar to the UI 400 described above, the content displayed in the UI 500 is provided by the content partner and is layered over the foreground 502.

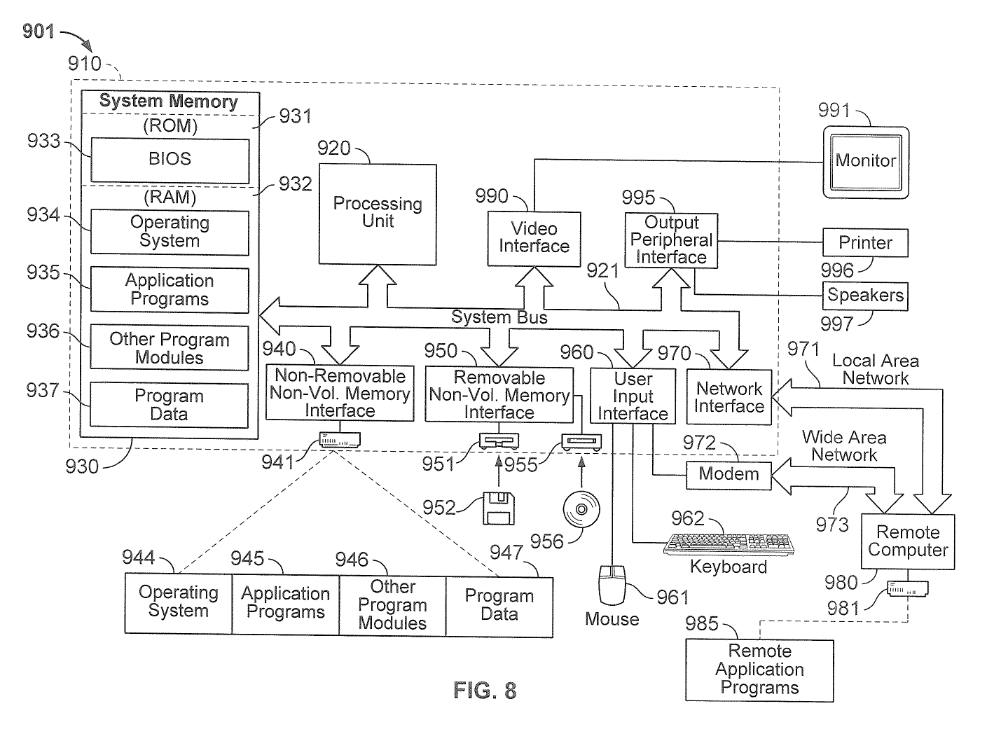

FIG. 8 illustrates an example of a suitable general computing system environment 901 for rendering a branded user interface as described above. It is understood that the term “computer” as used herein broadly applies to any digital or computing device or system. The computing system environment 901 is only one example of a suitable computing environment and is not intended to suggest any limitation as to the scope of use or functionality of the inventive system. Neither should the computing system environment 901 be interpreted as having any dependency or requirement relating to any one or combination of components illustrated in the exemplary computing system environment 901.

With reference to FIG. 9, an exemplary system for implementing the inventive system includes a general purpose computing device in the form of a computer 910. Components of computer 910 may include, but are not limited to, a processing unit 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 910 may include a variety of computer readable media. Computer readable media can be any available media that can be accessed by computer 910 and includes both volatile and nonvolatile media, removable and non-removable media. By way of example, and not limitation, computer readable media may comprise computer storage media and communication media. Computer storage media includes volatile and nonvolatile, as well as removable and non-removable media implemented in any method or technology for storage of information such as computer readable instructions, data structures, program modules or other data. Computer storage media includes, but is not limited to, random access memory (RAM), read only memory (ROM), EEPROM, flash memory or other memory technology, CD-ROMs, digital versatile discs (DVDs) or other optical disc storage, magnetic cassettes, magnetic tapes, magnetic disc storage or other magnetic storage devices, or any other medium which can be used to store the desired information and which can be accessed by computer 410. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 930 includes computer storage media in the form of volatile and/or nonvolatile memory such as ROM 931 and RAM 932. A basic input/output system (BIOS) 933, containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 9 illustrates operating system 934, application programs 935, other program modules 936, and program data 937.

The computer 910 may also include other removable/non-removable, volatile/nonvolatile computer storage media. By way of example only, FIG. 9 illustrates a hard disc drive 941 that reads from or writes to non-removable, nonvolatile magnetic media and a magnetic disc drive 951 that reads from or writes to a removable, nonvolatile magnetic disc 952. Computer 910 may further include an optical media reading device 955 to read and/or write to an optical media.

Other removable/non-removable, volatile/nonvolatile computer storage media that can be used in the exemplary operating environment include, but are not limited to, magnetic tape cassettes, flash memory cards, DVDs, digital video tapes, solid state RAM, solid state ROM, and the like. The hard disc drive 941 is typically connected to the system bus 921 through a non-removable memory interface such as interface 940. Magnetic disc drive 951 and optical media reading device 955 are typically connected to the system bus 921 by a removable memory interface, such as interface 950.

The drives and their associated computer storage media discussed above and illustrated in FIG. 9, provide storage of computer readable instructions, data structures, program modules and other data for the computer 910. In FIG. 9, for example, hard disc drive 941 is illustrated as storing operating system 944, application programs 945, other program modules 946, and program data 947. These components can either be the same as or different from operating system 934, application programs 935, other program modules 936, and program data 937. Operating system 944, application programs 945, other program modules 946, and program data 947 are given different numbers here to illustrate that, at a minimum, they are different copies.

A user may enter commands and information into the computer 910 through input devices such as a keyboard 962 and a pointing device 961, commonly referred to as a mouse, trackball or touch pad. Other input devices (not shown) may include a microphone, joystick, game pad, satellite dish, scanner, or the like. These and other input devices are often connected to the processing unit 920 through a user input interface 960 that is coupled to the system bus 921, but may be connected by other interface and bus structures, such as a parallel port, game port or a universal serial bus (USB). A monitor 991 or other type of display device is also connected to the system bus 921 via an interface, such as a video interface 990. In addition to the monitor, computers may also include other peripheral output devices such as speakers 997 and printer 996, which may be connected through an output peripheral interface 995.

The computer 910 may operate in a networked environment using logical connections to one or more remote computers, such as a remote computer 980. The remote computer 980 may be a personal computer, a server, a router, a network PC, a peer device or other common network node, and typically includes many or all of the elements described above relative to the computer 910, although only a memory storage device 981 has been illustrated in FIG. 9. The logical connections depicted in FIG. 9 include a local area network (LAN) 971 and a wide area network (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other means for establishing communication over the WAN 973, such as the Internet. The modem 972, which may be internal or external, may be connected to the system bus 921 via the user input interface 960, or other appropriate mechanism. In a networked environment, program modules depicted relative to the computer 910, or portions thereof, may be stored in the remote memory storage device. By way of example, and not limitation, FIG. 9 illustrates remote application programs 985 as residing on memory device 981. It will be appreciated that the network connections shown are exemplary and other means of establishing a communication link between the computers may be used.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

We claim:

1. A method of generating a user interface, comprising:
receiving a hue value, an image and a logo;
providing a background template, wherein the background template includes a mask, an image location and a logo location;
tinting the mask of the background template based in part on the hue value;
placing the image in the image location of the background template;
placing the logo in the logo location of the background template; and
layering gallery content over the background template.

2. The method as recited in claim 1, wherein:
the mask of the background template includes a gradient pattern.

3. The method as recited in claim 1, wherein:
the mask of the background template is divided into multiple quadrants; and
one of the multiple quadrants is designated as the image location.

4. The method as recited in claim 2, wherein tinting the mask of the background template includes:
determining a color associated with the hue value; and
tinting the gradient pattern of the mask with the color associated with the hue value.

5. The method as recited in claim 1, further comprising:
generating a watermark version of the image.

6. The method as recited in claim 5, wherein generating the watermark version of the image comprises:
de-saturating the image inserted into the image location;
applying the tinted mask over at least a portion of the de-saturated image; and
setting the opacity of the de-saturated image.

7. The method as recited in claim 5, wherein generating the watermark version of the image comprises:
layering the tinted mask over at least a portion of the image inserted into the image location; and
setting the opacity of the image.

8. The method as recited in claim 6, wherein the hue value comprises a hue value based on the hue, saturation, value model.

9. The method as recited in claim 1, wherein layering the gallery content over the background template comprises:
retrieving at least one gallery image;
layering the at least one gallery image over the background template;
retrieving text associated with the at least one gallery image; and
layering the text associated with the at least one gallery image over the background template.

10. The method as recited in claim 9, further comprising:
determining the contrast level of the text associated with the at least one gallery image based in part on the hue value.

11. A method of generating a branded background for a user interface, comprising:
receiving information from a content partner, wherein the information includes a hue value, a logo and an image;
providing a background template having a mask with a gradient pattern, an image location and a logo location;
tinting the gradient pattern of the mask based in part in the information received from the content partner;
inserting the image in the image location of the background template; and
inserting the logo in the logo location of the background template.

12. The method as recited in claim 11, wherein inserting the image in the image location comprises:
inserting the image in the image location of the background template;
generating a de-saturated version of the image inserted into the image location of the background template;
layering the mask with the tinted pattern over the de-saturated version of the image; and
setting the opacity of the de-saturated version of the image.

13. The method as recited in claim 11, wherein the mask is divided into multiple quadrants.

14. The method as recited in claim 13, wherein the logo location is located in one of the multiple quadrants.

15. The method as recited in claim 13, wherein the image location is located in one of the multiple quadrants.

16. The method as recited in claim 11, wherein tinting the gradient pattern in the mask comprises:
determining a color associated with the hue value, wherein the hue value is based on an hue-saturation-value color model; and
tinting the gradient pattern of the mask with the color.

17. A system for generating a branded background of a user interface, comprising:
a memory configured to store a background template having a background mask, a hue value, a logo, and a locator associated with an image;
a processor configured to retrieve the image, place the image in the background template, place the logo in the background template, and tint the background mask with a color associated with the hue value.

18. The system as recited in claim 17, wherein:
the processor is further configured to retrieve gallery content stored on a server maintained by the content provider and layer the gallery content over the background template.

19. The system as recited in claim 18, wherein:
the hue value comprises a value based on a hue-saturation-value color model.

20. The system as recited in claim 19, wherein:
the hue value comprises a value between 0-360.
